(19) United States
(12) Patent Application Publication
(10) Pub. No.: US 2014/0173455 A1
(43) Pub. Date: Jun. 19, 2014

(54) DISPLAY DEVICE, DISPLAY SYSTEM, METHOD OF CONTROLLING DISPLAY DEVICE AND SIGNAL PROCESSING DEVICE

(71) Applicant: FUNAI ELECTRIC CO., LTD., Osaka (JP)

(72) Inventors: Yoshiharu SHIMIZU, Osaka (JP); Kensuke KONO, Osaka (JP)

(73) Assignee: FUNAI ELECTRIC CO., LTD., Osaka (JP)

(21) Appl. No.: 14/072,935

(22) Filed: Nov. 6, 2013

(30) Foreign Application Priority Data
Dec. 14, 2012 (JP) 2012-273550

(51) Int. Cl. H04L 29/08

(52) U.S. Cl. CPC H04L 67/10
USPC 715/748; 709/219; 715/777

(57) ABSTRACT

There are provided a display device, a display system, a method of controlling such a display device and a signal processing device in which a plurality of information devices can be simultaneously connected, information stored in the information devices is displayed and the information can easily be exchanged. In display devices 1, 1A and 1B, a display system and a method of controlling such display devices, a plurality of information devices A, B and C are simultaneously connected, information on content is displayed at one time, a content type corresponding to each of information devices is confirmed, the information device to which the selected content can be copied is determined and copying processing is started between the copying source and the copying destination. In a signal processing device 10, these functions are provided, and a conventional TV device can be used as a display device.

This application is based on Japanese Patent Application No. 2012-273550 filed on Dec. 14, 2012, the contents of which are hereby incorporated by reference.

### BACKGROUND OF THE INVENTION

1. Field of the Invention

The present invention relates to a display device and a display system that display content stored in a plurality of information devices, that can easily confirm it and that allow the content to be copied between these information devices, a method of controlling such a display device and a signal processing device.

2. Description of Related Art

In recent years, high-performance communication terminals such as a smart phone incorporating various applications have been developed. High-performance information devices (hereinafter referred to as tablet terminals), such as tablet PC, that are portable are also developed; as these types of information devices have higher performance, users can utilize various types of content.

Content recording devices such as a HDD recorder that can record a large amount of content such as TV programs are widely used; portable information devices such as a smart phone and a tablet terminal are used to reproduce moving images, music and like outside.

The user converts various types of content into a file format that can be reproduced by a mobile device and copies them to the device, and thereby can reproduce the content outside. However, since the file format that can be reproduced may differ depending on the device, the user is required to have knowledge on each exchange method.

As a television reception device is digitized, an information device such as a portable information terminal is connected to the television reception device, and application information, video data and the like stored in the information device are transmitted and displayed.

For example, the present applicant has already proposed a portable information processing device that can use a mirror display mode in which the portable information processing device is directly connected to an external display device without intervention of a network to display the same data as an internal display unit and an expansion display mode in which different items of data are displayed (for example, see patent document 1; JP-A-2011-217236).

A communication method of transmitting, between information devices such as a portable communication terminal and a portable game terminal, content stored in one device to another device has already been performed. For example, with a wireless communication method such as infrared communication, Bluetooth (registered trademark), WiFi or the like, it is possible to exchange various types of information and data.

Although information devices are connected to allow communication, and thus information stored in those information devices can be exchanged, information devices such as a portable communication terminal and a tablet terminal are small and have a small display screen, with the result that disadvantageously, it is difficult to visually recognize information and it is impossible to easily perform an operation.

Hence, preferably, each of the information devices is connected to a display device having a large screen so as to allow communication, and an information exchange operation is performed while information to be exchanged is easily being confirmed, and the information exchange operation can be easily performed on a large screen without a complicated operation procedure being followed.

In other words, it is preferable to provide a display device and a display system where, regardless of the type of device to which they are connected, the information exchange operation can easily be performed, where each information device is connected to the display device having a large screen and where various types of information can be exchanged through the large screen with a series of simple operations and a method of controlling such a display device. When a signal processing device that achieves such a function with a household TV device is provided, it is possible to further enhance inconvenience to acquire usability.

### SUMMARY OF THE INVENTION

The present invention is made in view of the foregoing problem; an object of the present invention is to provide a display device and a display system in which a plurality of information devices can be simultaneously connected, information stored in the information devices is displayed and the information can easily be exchanged, a method of controlling such a display device and a signal processing device.

To achieve the above object, according to the present invention, there is provided a display device including: a connection section that connects a plurality of information devices; a display section that can display, on a display unit, information on content stored in the plurality of information devices; a content type confirmation section that confirms a content type to which each of the information devices can correspond and a content type of content stored in each of the information devices; a determination section that determines the information device which can correspond to content selected and predetermined from the information displayed on the display unit; and a copying processing section that, when the information device which can correspond to the predetermined content is selected as a copying destination of the predetermined content, makes the information device having the predetermined content and the information device of the copying destination communicate with each other, and that starts copying processing on the predetermined content.

In this configuration, a plurality of information devices are connected to the display device so as to allow communication, and thus it is possible to simultaneously display, on the large screen of the display device, the information on the content stored in the information devices and easily confirm it. Since content to be desired to be copied is selected, and thus only the information device on which copying can be performed is determined, it is possible to start the copying processing on the content on only the information device on which copying can be performed. In other words, in the present invention, it is possible to obtain the display device that can simultaneously connect a plurality of information devices, that displays information stored in the information devices and that thereby can easily exchange the information.

The display device of the present invention configured as described above includes a copying destination limitation section that prevents, through the determination section, the information device which is determined to be unable to correspond to the predetermined content from being the copying destination of the predetermined content. In this configuration, even if copying is attempted to be performed on the information device which does not correspond to the content to be desired to be copied, the copying operation is automatically limited, with the result that it is possible to reliably prevent the copying processing from being performed on the information device on which copying cannot be performed.

In the display device of the present invention configured as described above, the display section simultaneously displays the information stored in at least two or more information devices among the plurality of information devices. In this configuration, it is possible to simultaneously display, on the large screen of the display device, the information on the content stored in the information devices and easily confirm it.

In the display device of the present invention configured as described above, the determination section compares a content type of the predetermined content with the content type to which each of the information devices can correspond so as to determine the information device that can correspond to the predetermined content. In this configuration, since the information device to which the desired content can be copied is automatically determined, it is possible to perform the copying processing on only the information device on which copying can be performed.

In the display device of the present invention configured as described above, the determination section includes a copyability explicitly showing function of determining and explicitly showing the information device to which the predetermined content can be copied. In this configuration, when the content to be desired to be copied is selected, the information device on which copying can be performed is automatically and explicitly shown, with the result that the user can easily find the information device to which the selected content can be copied without needing to confirm, one by one, whether or not the content has a file format which can be copied.

In the display device of the present invention configured as described above, the copying processing section provides an instruction to copy the content according to an operation of dropping the information on the content by a drag and drop method. In this configuration, by performing the drag and drop method on the screen of the display device, it is possible to easily copy the content from the information device of the copying source to the information device of the copying destination.

In the display device of the present invention configured as described above, the display section includes: an image display function of dividing a display image of each of the information devices on an individual display area basis and producing a display at one time; and an identification image display function of acquiring image information with which the selected content is identified from the information device storing the content and overwriting the display image as an identification image with the acquired image information and displaying the identification image, and the identification image is dropped on the display area corresponding to the information device on which copying can be performed such that the copying processing is started. In this configuration, content that is desired to be copied to a predetermined information device is selected, and thus an identification image corresponding to the content is obtained; an information device on which copying can be performed is recognized, and an instruction to start an operation of copying the content between the information device of the copying source and the information device of the copying destination can be provided by the drag and drop method on the identification image on the screen of the display device. In other words, in the present invention, it is possible to obtain the display device that can simultaneously connect a plurality of information devices, that displays the information stored in the information devices at one time and that can easily exchange the information.

In the display device of the present invention configured as described above, the display section includes an identification image display function of acquiring image information with which the content stored in the information devices is identified and displaying the image information as an identification image at one time, and the identification image is dropped on the information device displayed as an information device on which copying can be performed such that the copying processing is started. In this configuration, since the identification image is used, and thus the details of the content can be visually and easily recognized, it is possible to copy the desired information device without erroneously recognizing the desired content.

In the display device of the present invention configured as described above, the image information is thumbnail information, and the identification image is a thumbnail image. In this configuration, since the thumbnail image is used, and thus the details of the content can further be visually and easily recognized, it is possible to reliably copy the desired information device without erroneously recognizing the desired content.

In the display device of the present invention configured as described above, the background colors of the display area corresponding to the information device to which the selected content can be copied and the display area corresponding to the information device of a copying source are made to be the same first color, and the background color of the display area corresponding to the information device to which copying cannot be performed is made to be a second color different from the first color. In this configuration, it is possible to easily confirm the information device to which the selected content can be copied, and thus it is possible to perform the copying processing on the desired content without erroneously performing it.

In the display device of the present invention configured as described above, a tab display is produced on the plurality of information devices that are connected. In this configuration, it is possible to easily confirm the information device that is connected to the display device.

In the display device of the present invention configured as described above, any one or both of a size and a color of a tab corresponding to the information device to which the selected content can be copied are changed, and the thumbnail image is dropped on the tab corresponding to the information device on which copying can be performed such that the copying processing is started. In this configuration, it is possible to easily confirm the information device to which the desired content can be copied, and thus it is possible to easily perform the copying processing.

In the display device of the present invention configured as described above, any one or both of a size and a color of a tab corresponding to the information device of a copying source and the information device on which copying cannot be performed are simultaneously changed. In this configuration, it is possible to easily confirm the information device to which the desired content cannot be copied.

According to the present invention, there is provided a display system that is configured by connecting a plurality of information devices to the display device configured as described above, where the display device includes: a connection function that connects a plurality of information devices; a display function that can display, on a display unit, information on content stored in the information devices; a content type confirmation function that confirms a content type to which each of the information devices can correspond and a content type of content stored in each of the information devices; a determination function that determines the information device which can correspond to content selected and predetermined from the information displayed on the display unit; and a copying processing function that, when the information device which can correspond to the predetermined content is selected as a copying destination of the predetermined content, makes the information device having the predetermined content and the information device of the copying destination communicate with each other, and that starts copying processing on the predetermined content, and an operation on a screen of the display device allows the copying processing from the information device of a copying source to the information device of a copying destination.

In this configuration, on a large display screen such as a display device, information on the content stored in the information devices is displayed, and it is possible to easily perform the copying processing on the desired content. In other words, in the present invention, it is possible to obtain the display system that can simultaneously connect a plurality of information devices, that displays the information stored in the information devices at one time and that can easily exchange the information.

According to the present invention, there is provided a method of controlling the display device configured as described above including: a connection step of connecting a plurality of information devices; a display step of being able to display, on a display unit, information on content stored in the information devices; a content type confirmation step of confirming a content type to which each of the information devices can correspond and a content type of content stored in each of the information devices; a determination step of determining the information device which can correspond to content selected and predetermined from the information displayed on the display unit; and a copying processing step of, when the information device which can correspond to the predetermined content is selected as a copying destination of the predetermined content, making the information device having the predetermined content and the information device of the copying destination communicate with each other, and of starting copying processing on the predetermined content, where an operation on a screen of the display device allows the copying processing from the information device of a copying source to the information device of a copying destination.

In this configuration, it is possible to obtain the method of controlling the display device that can simultaneously connect a plurality of information devices through the connection step, that can display the information stored in the information devices through the display step, that can confirm the information device to which the predetermined content can be copied through the content type confirmation step and the determination step and that can easily exchange the information through the copying processing step.

According to the present invention, there is provided a signal processing device including: a connection function that connects a plurality of information devices; a display function that can display, on a display unit, information on content stored in the plurality of information devices; a content type confirmation function that confirms a content type to which each of the information devices can correspond and a content type of content stored in each of the information devices; a determination function that determines the information device which can correspond to content selected and predetermined from the information displayed on the display unit; and a copying processing function that, when the information device which can correspond to the predetermined content is selected as a copying destination of the predetermined content, makes the information device having the predetermined content and the information device of the copying destination communicate with each other, and that starts copying processing on the predetermined content, where an operation on a screen of the display device allows the copying processing from the information device of a copying source to the information device of a copying destination.

In this configuration, on a large display screen such as a TV device, information on the content stored in the information devices is displayed, and it is possible to easily perform the copying processing on the desired content. In other words, in the present invention, it is possible to obtain the signal processing device that can simultaneously connect a plurality of information devices, that displays the information stored in the information devices at one time and that can easily exchange the information.

### BRIEF DESCRIPTION OF THE DRAWINGS

FIG. 1 A block diagram showing the configuration of connection between a display device of the present invention and information devices connected to the display device;

FIG. 2 A schematic illustrative diagram showing a first embodiment in which the display images of a plurality of information devices connected to the display device are displayed at one time;

FIG. 3 A schematic illustrative diagram showing whether selected content can be copied or cannot be copied;

FIG. 4 A schematic illustrative diagram showing a state in which a region where copying cannot be performed is dragged;

FIG. 5 A schematic illustrative diagram showing a state in which dragging is performed up to a region where copying can be performed and then dropping is performed;

FIG. 6 A flowchart showing a procedure in which a plurality of information devices are connected to the display device of the first embodiment and a screen display is produced;

FIG. 7 A flowchart showing a procedure in which a plurality of information devices are connected to the display device of the first embodiment and copying processing on the content is performed;

FIG. 8 A schematic illustrative diagram showing a second embodiment in which a tab display is produced on the information device connected to the display device, and in which content information stored in the information devices is displayed at one time;

FIG. 9 A schematic illustrative diagram showing a state where a tab corresponding to the information device on which copying can be performed is enlarged;

FIG. 10 A schematic illustrative diagram showing a state where an instruction is provided to perform an operation of dropping a thumbnail on the tab shown in FIG. 9 to copy the content;

FIG. 11 A flowchart showing a procedure in which a tab display is produced on the information device connected to the display device of the second embodiment and in which a desired thumbnail is displayed;

FIG. 12 A flowchart further showing a procedure in which the copying processing is performed through the selected thumbnail;

FIG. 13 A block diagram showing a step of operating the display device according to the present invention;

FIG. 14 A block diagram showing the outline of a display step;

FIG. 15 A block diagram showing a configuration of connection between a TV device including the display device of the present invention and the information devices; and

FIG. 16 A block diagram showing a configuration of connection between a signal processing device of the present invention, the information devices and the TV device.

### DETAILED DESCRIPTION OF PREFERRED EMBODIMENTS

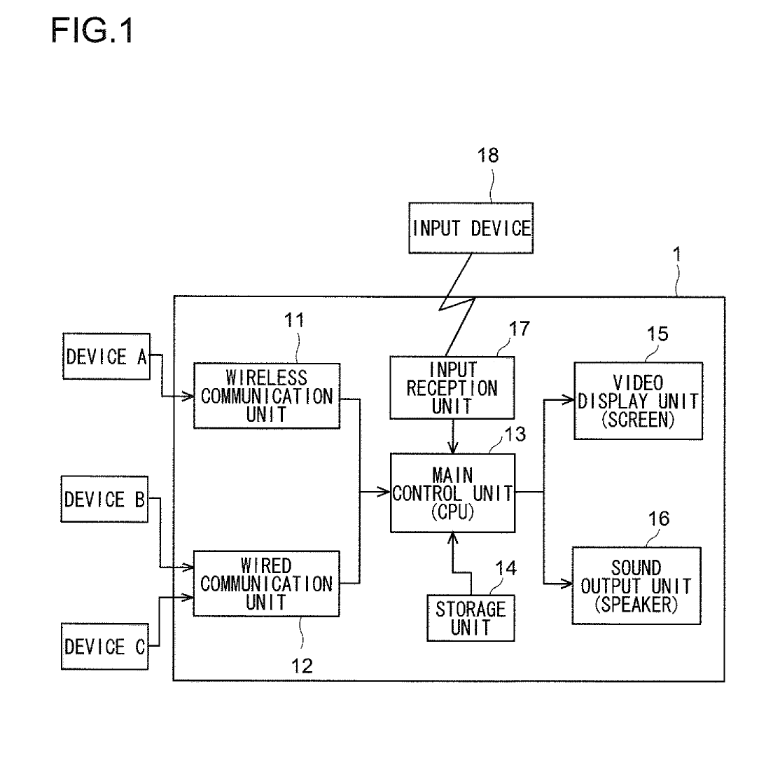

Embodiments of the present invention will be described below with reference to drawings; the present invention is not limited by these embodiments. Like members are identified with like symbols, and their description will not be repeated as necessary. The configurations of a display device and a display system according to the present invention will first be described with reference to FIG. 1.

As shown in FIG. 1, the display device of the present embodiment connects a plurality of information devices (for example, three devices, that is, an information device A, an information device B and an information device C) to the display device 1 such that they can simultaneously communicate with each other, and performs copy processing between devices to which information (information on content) stored in the information devices can be copied.

The information devices A, B and C are, for example, a smart phone, a tablet terminal and other portable high-performance information devices. The content described here is a combination of text and an image, and sound, video and the like, and includes various things such as a photograph, music and a movie and furthermore applications for performing a game and various processing operations.

The display device 1 includes a wireless communication unit 11, a wired communication unit 12, a main control unit 13 (CPU), a storage unit 14, a video display unit 15 (corresponding to the display unit of the present invention) and a sound output unit 16. As long as the wireless communication unit 11 can perform near field communication, a wireless communication method such as a wireless LAN (WiLAN or WiFi), Bluetooth (registered trademark) or ZigBee (registered trademark) can be adopted.

The display device 1 has not only the wireless communication unit 11 but also the wired communication unit 12. Although the wired communication unit 12 has, for example, a wired communication method that conforms to the USB standard, it may have a HDMI (high-definition multimedia interface) method, a MHL (mobile high-definition link) method, a wired communication method conforming to DisplayPort standard or a wired communication method conforming to Thunderbolt standard. Hence, the display device 1 is connected to the information device A and the information device B through the wireless communication unit 11 so as to allow communication, and is connected to the information device C through the wired communication unit 12 so as to allow communication, with the result that the display device 1 can be simultaneously connected to a plurality of (three) information devices.

For example, a plurality of information devices A, B and C are simultaneously connected to the display device 1, information on content is displayed at one time, content types that can correspond to the information devices are confirmed, the information device to which the selected content can be copied is determined and copying processing on the content is stated between the information device of a copying destination and the information device of a copying source. For example, wireless communication between the communication devices thereof is performed to copy predetermined content to other information devices.

In the copying processing, information displayed on the display unit 15 of the display device 1 is moved by a predetermined operation from the copying source also displayed on the display unit 15 to a display area corresponding to the information device of the copying destination, and thus a copying processing instruction is provided, with the result that the copying processing is started between the information device of the copying source and the information device of the copying destination.

For example, with an input device 18, such as a remote controller or a pointer, that can communicate with the main control unit 13 through an input reception unit 17, on the display unit 15 of the display device 1, a cursor operation or a pointer operation is performed to select and move predetermined content. Since as described above, through the large screen of the display device 1, it is possible to confirm and move content information, it becomes easy for the user to perform the operation, with the result that it is possible to provide the display device 1 having excellent usability.

Specifically, the display device 1 of the present embodiment includes: a connection section that connects a plurality of information devices through the wireless communication unit 11 and the wired communication unit 12; a display section that can display, on a display unit 15, information on content stored in the plurality of information devices; a content type confirmation section that confirms a content type to which each of the information devices can correspond and a content type of content stored in each of the information devices; a determination section that determines the information device which can correspond to content selected and predetermined from the information displayed on the display unit 15; and a copying processing section that, when the information device which can correspond to the predetermined content is selected as a copying destination of the predetermined content, makes the information device having the predetermined content and the information device of the copying destination communicate with each other, and that starts copying processing on the predetermined content.

In this configuration, the information on the content stored in the information devices A, B and C is simultaneously displayed on the large screen of the display device 1, and thus it is possible to easily confirm the content that is available. Content that is desired to be copied to a predetermined information device is selected, a copying start instruction is provided by performing an operation on the screen of the display device 1 and thus it is possible to copy the content from the information device of the copying source to the information device of the copying destination. In other words, in the present embodiment, it is possible to obtain the display device 1 that can simultaneously connect a plurality of information devices, that displays information stored in the information devices and that thereby can easily exchange the information.

Furthermore, preferably, a copying destination limitation section is provided that prevents, through the determination section, the information device which is determined to be unable to correspond to the predetermined content from being the copying destination of the predetermined content. In this configuration, even if copying is attempted to be performed on the information device which does not correspond to the content to be desired to be copied, the copying operation is automatically limited, with the result that it is possible to reliably prevent the copying processing from being performed on the information device on which copying cannot be performed.

Preferably, the display section simultaneously displays the information stored in at least two or more information devices among the plurality of information devices A, B and C. In this configuration, it is possible to simultaneously display, on the large screen of the display device 1, the information on the content stored in the information devices A, B and C and easily confirm it. Naturally, a configuration may be adopted in which the information stored in the information devices A, B and C is displayed at one time.

Preferably, the content type confirmation section includes a content type acquisition function of acquiring the content type of content stored in the information devices A, B and C and a content type corresponding to the information devices A, B and C; the determination section includes a determination function of comparing the acquired content type with the content type corresponding to the information devices A, B and C to determine whether or not the content can be copied. In this configuration, since the information device to which the desired content can be copied is automatically determined, it is possible to perform the copying processing on only the information device on which copying can be performed.

Preferably, the determination section includes a copyability explicitly showing function of determining and explicitly showing the information devices A, B and C to which the predetermined content can be copied. In this configuration, when the content to be desired to be copied is selected, the information device on which copying can be performed is automatically and explicitly shown, with the result that the user can easily find the information device to which the selected content can be copied without needing to confirm, one by one, whether or not the content has a file format which can be copied.

Preferably, the copying processing section provides an instruction to copy the content to the information devices A, B and C which are determined to be information devices on which copying can be performed, according to an operation of dropping the information on the content by the drag and drop method. In this configuration, the drag and drop method is performed on the large screen of the display device 1, and thus it is possible to easily copy the content from the information device of the copying source to the information device of the copying destination.

A first embodiment in which a plurality of information devices are simultaneously connected, display images and content information in the information devices are simultaneously displayed and the content stored in one information device is copied to another information device and a second embodiment in which a plurality of information devices are simultaneously connected, not only the content information stored in the information devices but also the tabs corresponding to the information devices are displayed at one time and the content information is moved by the drag and drop method to the corresponding tab to copy the content stored in one information device to another information device will now be described.

### First Embodiment

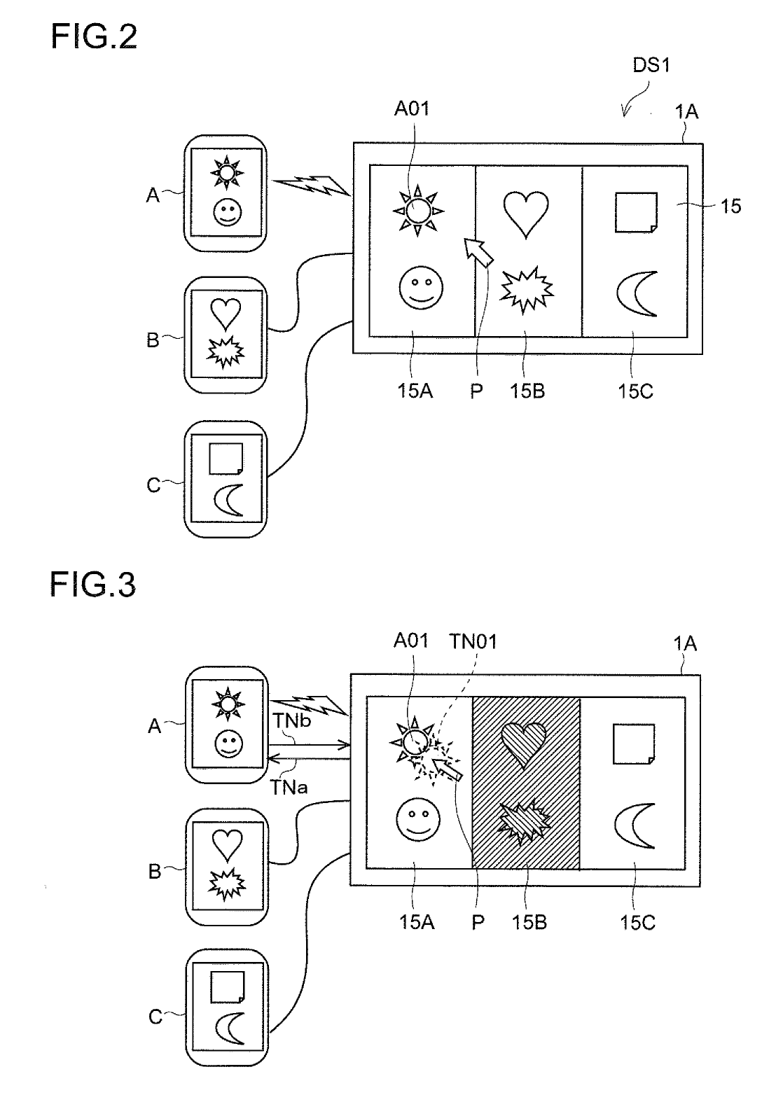

A display device and a display system according to the first embodiment will first be described with reference to FIGS. 2 to 7.

The display system DS1 of the first embodiment shown in FIG. 2 is configured by simultaneously connecting three information devices, that is, the information device A, the information device B and the information device C to the display device 1A.

As with the display device 1 shown in FIG. 1, the display device 1A includes the wireless communication unit 11 and the wired communication unit 12; each of the communication units can simultaneously connect a plurality of information devices. For example, FIG. 2 shows a state where the information device A is connected by a wireless communication method, and the information device B and the information device C are connected by a wired communication method.

Immediately after the connection, on the display unit 15, for example, the display images of the information devices A, B and C are displayed. In other words, since the images displayed on the information devices A, B and C are displayed without being processed, it is possible to confirm, with the details of the display, that the three information devices A, B and C are connected to the display device 1A and a correspondence relationship between the individual display areas of the display unit 15 and the information devices A, B and C.

Hence, when information on the content is displayed on the information devices A, B and C, in the display device 1A, the information devices communicates with each other, the displayed information is acquired and the same information is also displayed on the display unit 15. The information on the content is preferably information with which the content can be identified; for example, the name of the content, part of the image, a thumbnail image, an identification image such as an application image indicating a game or an application or the like can be used.

In FIG. 2, a display area 15A corresponds to the information device A, a display area 15B corresponds to the information device B, and a display area 15C corresponds to the information device C. An image A01 shown in the figure is simply an example of the display image, and does not allow a drag and drop operation unlike a thumbnail image TN01, which will be described later.

In the figure, a pointer P is shown, the pointer P is operated with the input device 18 and thus it is possible to perform the followings: it is possible to select desired content; when an information device that can correspond to the selected and predetermined content is selected as the copying destination of the predetermined content, communication is made to be performed between the information device having the predetermined content and the information device of the copying destination, and copying processing on the predetermined content is started; and it is possible to prevent information devices that cannot correspond to the predetermined content from being the copying destination of the predetermined content.

For example, as shown in FIG. 3, even in a state where the image A01 is simply displayed, when the pointer P is moved to the image A01 and the image A01 is clicked, processing for requiring content information corresponding to the image A01 is started, the information device A having the content corresponding to the image A01 transmits the predetermined content information to the display device 1A and the image A01 is overwritten with the predetermined content information.

The content information is information that can identify the content, and is, for example, a thumbnail. Hence, when the pointer P is operated to select the image A01, a thumbnail requirement (thumbnail requirement TNa) is performed on the information device A, and a predetermined thumbnail is returned (thumbnail return TNb) from the information device A according to the requirement.

At the same time, whether or not the other connected information devices B and C can correspond to the corresponding content or whether or not copying can be performed is determined, and the information device determined to be an information device on which copying can be performed or the information device determined to be an information device on which copying cannot be performed is explicitly indicated.

For example, the display device 1A confirms, through a content type confirmation section and a determination section included therein, the content type of content stored in each information device and the content type to which each information device can correspond, compares these to determine on each information device whether or not the information device can correspond to the required content information and thereby can determine on each information device whether or not new content can be copied to the information device.

A function of overwriting the image A01 as the thumbnail image with thumbnail information acquired as information for identifying the content (identification image display function) is provided; it is possible to move, with the pointer P, by a drag and drop method, the thumbnail image with which overwriting has been performed and thereby provide an instruction to start copying processing.

In this case, preferably, the background colors of a display area corresponding to the information device to which the selected content can be copied and a display area corresponding to the information device of the copying source are made to be the same first color, and the background color of a display area corresponding to the information device on which the selected content cannot be copied is made to be a second color different from the first color. In the configuration having such a copyability explicitly showing function, it is possible to easily confirm the information device to which the selected content can be copied, and it is possible to perform the copying processing on the desired content without fail, with the result that the operation is made easy to acquire usability.

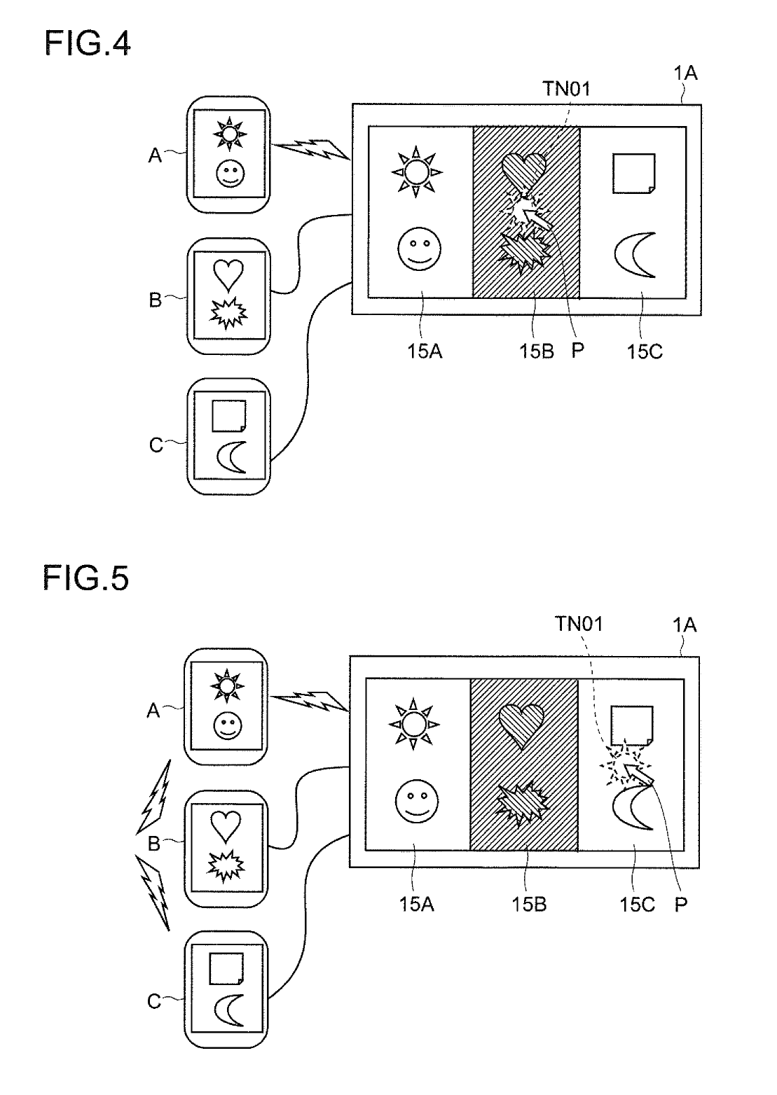

For example, FIGS. 3 and 4 show an example where the color of the display area 15B corresponding to the information device B determined to be an information device on which copying cannot be performed is turned dark. As is also understood from the figures, when the user selects the content desired to be copied, the background color of the display area 15B corresponding to the information device B determined to be an information device on which copying cannot be performed is made to be the second color different from the background color (first color) of the display area corresponding to the information device C determined to be an information device to which the content of the copying source and the selected content can be copied.

Hence, when the user selects the content on which the copying processing is desired to be performed, the side of the display device 1A selects and displays the information device to which the selected content can be copied, and thus the user himself does not need to make a determination on each information device whether or not the content can be copied, with the result that it is possible to easily exchange information without being aware of the type of information device that is connected to the display device 1A.

Although the thumbnail image TN01 corresponding to the selected content can be moved by the drag and drop method from the information device A of the copying source to the information device C determined to be an information device to which the content can be copied, the thumbnail image TN01 cannot be moved to the information device B determined to be an information device on which copying cannot be performed. In other words, the display area 15C having the same background color as the display area 15A corresponding to the information device A of the copying source falls within a drop operation effective region whereas the display area 15B having the different background color falls within a drop operation ineffective region.

In other words, the display device 1A includes: the copying processing section that, when an information device which can correspond to predetermined content is selected as the copying source of the predetermined content, makes the information device having the predetermined content and the information device of the copying destination communicate with each other to start the copying processing on the predetermined content; and the copying destination limitation section that prevents an information device which cannot correspond to the predetermined content from being the copying destination of the predetermined content.

Hence, as shown in FIG. 4, even when in the region of the display area 15B where its color has been turned dark, the thumbnail image TN01 is dragged and dropped, such an operation is determined to be ineffective whereas as shown in FIG. 5, when the pointer P is moved to the display area 15C, and thus the drag and drop operation on the thumbnail image TN01 becomes effective. As described above, the thumbnail image TN01 is moved to the display area 15C and is dropped, and thus an instruction to start an operation of copying, to the information device C, the content corresponding to the thumbnail image TN01 is provided.

To provide an instruction to start the processing for copying, to the information device C, the content corresponding to the thumbnail image TN01 is to provide a transmission instruction to the information device A to transmit, through the main control unit 13, the corresponding content to the information device C, to provide a reception instruction to the information device C to receive the content from the information device A and to start transmission and reception between the information device A and the information device C.

In other words, the display section included in the display device 1A of the present embodiment has an image display function of dividing the display image of each information device on an individual display area basis and producing a display at one time, and furthermore an identification image display function of acquiring image information with which the selected content is identified from the information device storing the content and of overwriting the display image as the identification image with the acquired image information to display the identification image; the identification image is dropped on the display area corresponding to the information device on which copying can be performed, and thus the copying processing is started.

In this configuration, on the large screen of the display device 1A, the display images of a plurality of information devices are simultaneously displayed, and thus it is possible to easily confirm the content information stored in the information devices. Content that is desired to be copied to a predetermined information device is selected, and thus an identification image corresponding to the content is obtained; an information device on which copying can be performed is recognized, and an instruction to start an operation of copying the content between the information device of the copying source and the information device of the copying destination can be provided by the drag and drop method on the identification image on the screen of the display device 1A. In other words, in the present embodiment, it is possible to obtain the display device 1A that can simultaneously connect a plurality of information devices, that simultaneously displays information stored in the information devices and that can easily exchange the information.

Preferably, the identification information is thumbnail information, and the identification image is a thumbnail image. In this configuration, content that is desired to be copied to a predetermined information device is selected, and thus a thumbnail image corresponding to the content is obtained; the thumbnail image with which the details of the content can be easily recognized is moved by the drag and drop method on the screen of the display device, and thus it is possible to provide an instruction to start an operation of copying the content between the information device of the copying source and the information device of the copying destination.

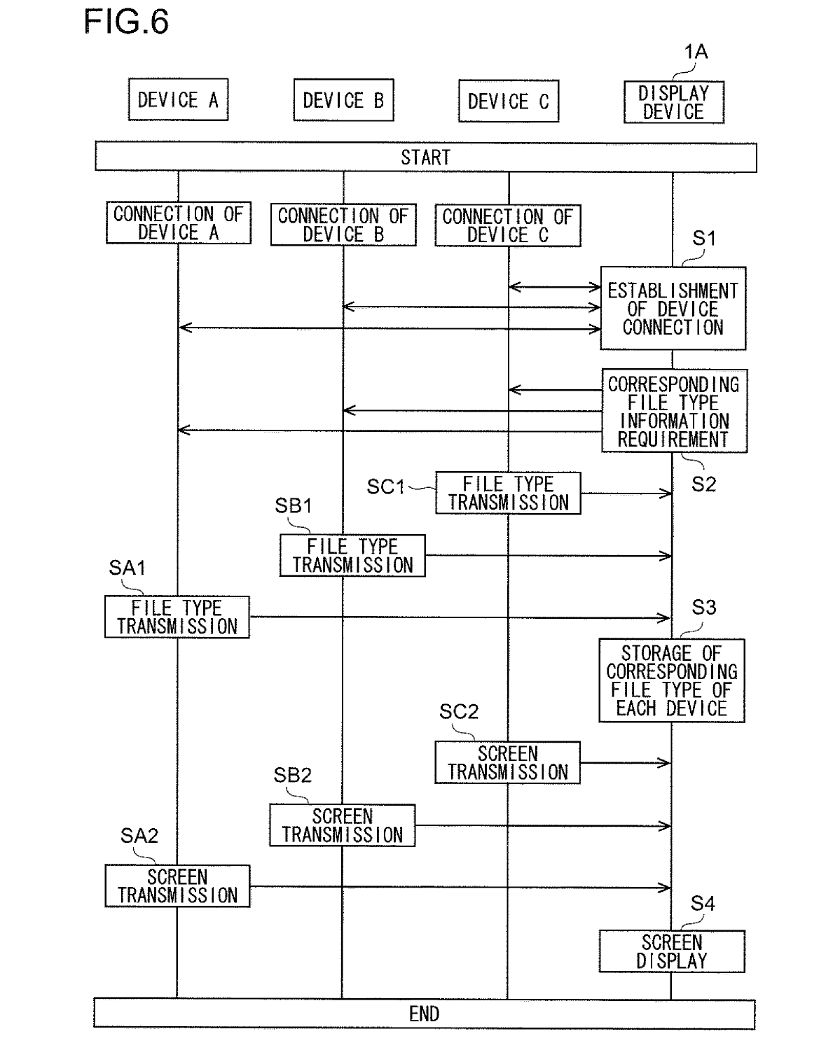

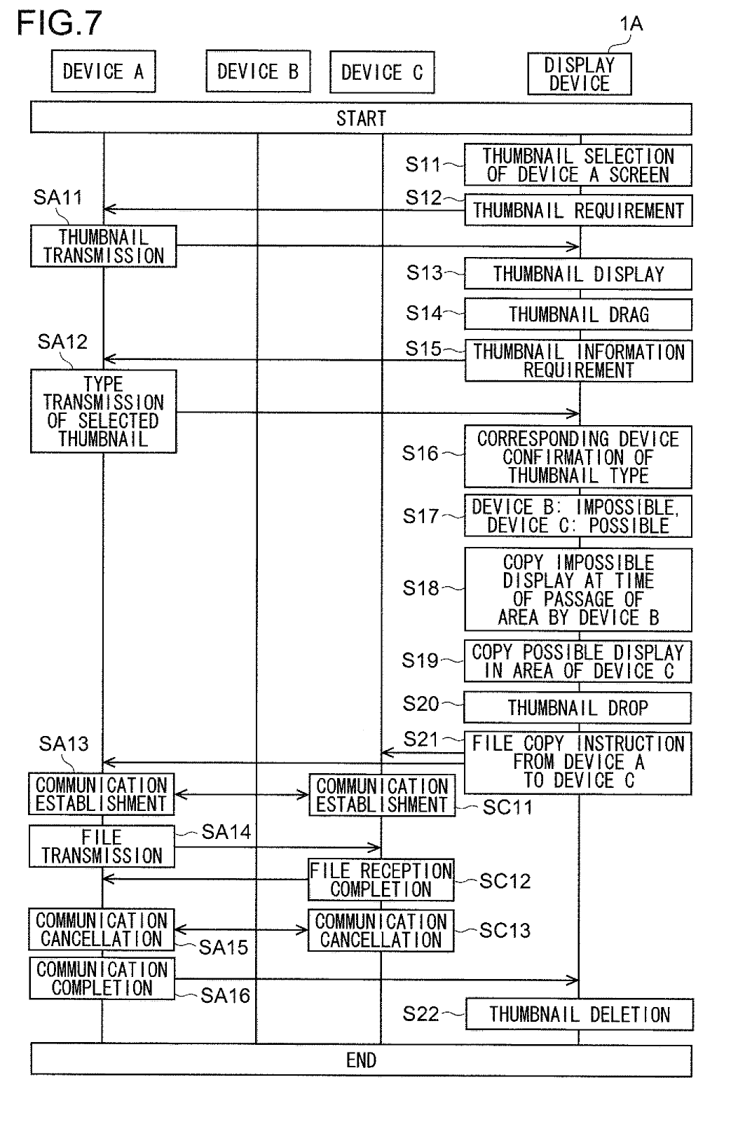

A method of controlling the display device 1A of the first embodiment will now be described with reference to the flowcharts shown in FIGS. 6 and 7. FIG. 6 is the flowchart showing an initial state where a plurality of information devices are connected to the display device and then a screen display is produced; FIG. 7 is the flowchart showing a procedure in which a plurality of information devices are connected to the display device and then the copying processing on content is performed.

As shown in FIG. 6, when the processing for connecting the information devices A, B and C to the display device 1A is started, the establishment of device connection in step S1 is performed by connecting the information devices through a section that connects the information devices (connection step).

Then, processing for confirming the image information, displayed by the information devices A, B and C and the content information on the content displayed on the screen is performed. For example, file information included in the content information is required (step S2) and is acquired. The file information (content information) is stored (step S3), screen information is obtained and a screen display corresponding thereto is produced (step S4) (display step).

In other words, when an information requirement on the file types in step S2 is performed, the information devices A, B and C transmit the file types (file type transmission SA1, SB1 and SC1), and the screen information is transmitted (screen transmission SA2, SB2 and SC2).

The steps shown in FIG. 6 are the connection step of connecting the display device and a plurality of information devices and the display step of producing a screen display; after both the steps, a content confirmation step, a determination step, a copying processing step and the like are performed.

After the operations in steps S1 to S4 described above, on the display unit 15 of the display device 1A, the display areas 15A, 15B and 15C respectively corresponding to the information devices A, B and C are displayed. The same display images as the information devices A, B and C are displayed on the display areas.

Then, the copying processing on the content shown in FIG. 7 is performed.

First, according to the screen operation of the display device 1A by the user, the main control unit 13 selects content information corresponding to the desired content (step S11: the thumbnail selection of the screen of the information device A: selection step). Then, a thumbnail requirement signal is provided to the information device A storing the selected content (step S12), and the information device A transmits a thumbnail to the display device 1A (step SA11).

When the display device 1A receives the thumbnail information from the information device A (thumbnail acquisition step), an image indicting the content information on the display area 15A is overwritten with the thumbnail information. In other words, a thumbnail display in step S13 is performed (thumbnail display step).

Then, the copying processing on the desired content is started. At the time of the start of the copying processing by the user, when the thumbnail image displayed on the display area 15A is selected, and thus a drag operation is started (step S14: drag step), an instruction to acquire a content type corresponding to this thumbnail is provided (corresponding to the thumbnail information requirement in step S15), and the information device A receiving such an instruction transmits the content type to the display device 1A (transmission of the type of the thumbnail selected in step SA12).

When the thumbnail type is received, that is, the content type is received (content type acquisition function), whether or not this content type can be copied is determined on each information device (determination function), the device corresponding to the thumbnail type in step S16 is confirmed (determination process) and a display (in step S17, the device B: impossible, the device C: possible) of its result is produced (copyability explicitly showing process).

The production of the display of the result is, for example, to change the background color shown in FIG. 3. In this stage, the user can find that the selected content can be copied to the information device C and that the selected content cannot be copied to the information device B, and performs the copying processing on the information device C which is determined to be an information device on which copying can be performed (copying processing process).

When the content stored in the information device A is copied to the information device C, the thumbnail image is dragged to the region of the display screen 15C corresponding to the information device C and is dropped (step S20). Then, this drop operation is determined to be effective, and the predetermined copying processing process is performed. In other words, an instruction to transmit the file copy is provided from the display device 1A to the information device A, and an instruction to receive the file copy is provided to the information device C (step S21).

Then, between the information device A and the information device C, a communication state is established (step SA13 and step SC11), and the transmission and reception of the content file are performed (step SA14). After the completion of the reception by the information device C, a file reception completion signal is transmitted to the information device A (step SC12).

Thereafter, the information device A and the information device C cancel the communication state (step SA15 and step SC13), and the information device A transmits a communication completion signal to the information device 1A (step SA16). When the display device 1A receives the communication completion signal from the information device 1A, the display device 1A preferably deletes the thumbnail image (step S22).

As described above, for example, even if the information device B to which the content stored in the information device A cannot be copied is selected, and the thumbnail image is attempted to be dragged to the region of the display area 15B corresponding to the information device B and be dropped, it is impossible to perform the dropping as described above. In other words, the display device 1A has a copying destination limitation function and a copying destination limitation step that prevent the information device B which cannot correspond to the predetermined content from being the copying destination of the predetermined content.

Through the processing procedure in steps S11 to S22 described above, the processing step of copying the content stored in the information device A to the information device C is completed. When a new type of copying processing is performed, an operation including the connection step, the display step, the content type confirmation step, the selection step, the thumbnail acquisition step, the thumbnail display step, the determination step, the drag step, the copyability explicitly showing step and the copy processing step corresponding to steps S11 to S22 is performed on new content, and thus the new type of copying processing can be performed.

According to the display device and the method of controlling the display device in the first embodiment described above, it is possible to easily confirm, on the large screen of the display device, the content stored in a plurality of information devices. Since the selection of the content to be copied allows the information device on which copying can be performed to be automatically displayed, on the large screen of the information device, it is possible to start the copying processing on the image (for example, the thumbnail image) corresponding to the content by the drag and drop method. In other words, in the present embodiment, it is possible to obtain the display device that can simultaneously connect a plurality of information devices, that displays the information stored in the information devices at one time and that can easily exchange the information.

### Second Embodiment

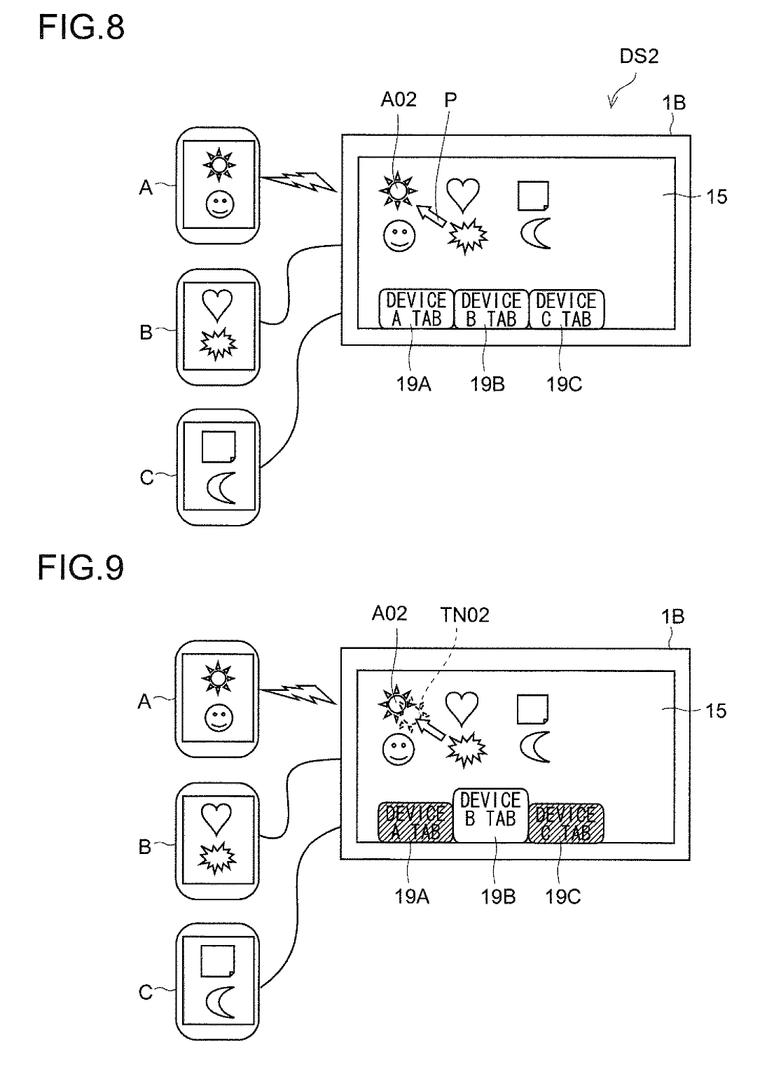

A display device and a display system according to the second embodiment will now be described with reference to FIGS. 8 to 12.

The display system DS2 of the second embodiment shown in FIG. 8 is configured by simultaneously connecting, as with the display system DS1 of the first embodiment, the three information devices, that is, the information device A, the information device B and the information device C to the display device. However, they differ in that at the time of the connection, the thumbnail image is previously acquired as the content information and is displayed, and that a display device 1B having a tab display unit is used to display tabs 19A, 19B and 19C corresponding to the information devices A, B and C which are connected.

As with the display device 1 shown in FIG. 1, the display device 1B also includes the wireless communication unit 11 and the wired communication unit 12; each of the communication units can be simultaneously connected to a plurality of information devices. For example, FIG. 8 shows a state where the information device A is connected by a wireless communication method and the information devices B and C are connected by a wired communication method.

Immediately after the connection, in the display unit 15, the content information (for example, the thumbnail image) corresponding to the content stored in the information devices A, B and C is acquired, and the content information is simultaneously displayed. For example, when the content information is displayed on the information devices A, B and C, the same content information (thumbnail image) is also displayed on the display unit 15 at one time.

The tab display unit is provided in the lower portion of the display unit 15, and thus a tab display is produced on the individual information devices A, B and C that are connected to the display device 1B. In other words, when the three information devices A, B and C are connected to the display device 1B, the tab display is produced on each of them, and the thumbnail images displayed as the display images thereof are simultaneously displayed.

In the figure, the pointer P is shown, and the pointer P is operated with the input device 18, and thus it is possible to select the content to be identified and perform the copying processing.

For example, as shown in FIG. 9, when the pointer P is moved to an image A02 (thumbnail image TN02) and is clicked, an operation of requiring a content type corresponding to the thumbnail image TN02 is started, and an information device to which this content can be copied is determined from the acquired content type.

That the information device which is determined to be an information device to which the content can be copied or the information device which is determined to be an information device on which copying cannot be performed is explicitly shown is the same. However, the present embodiment differs in that the tab display unit is utilized to display whether or not the information device is an information device to which the content can be copied. Since the other configurations are the same as in the first embodiment described above, their detailed description will not be repeated.

For example, FIG. 9 shows a state where the image A02 is selected through the pointer P, and thus it is possible to move the thumbnail image TN02 corresponding to this image by the drag and drop method.

Here, through a content type corresponding to the selected thumbnail image TN02, the information device to which this content can be copied is determined from the content information on each information device previously acquired, and its result is displayed on the tab display unit. For example, as illustrated in the figure, the tab 19B of the information device B on which copying can be performed is enlarged and displayed. Alternatively, a display obtained by changing the color or the brightness may be produced.

A method may be adopted in which the information device A of the copying source and the information device C determined to be an information device on which copying cannot be performed are displayed in the same color or are changed in the size and are displayed. In any of the methods, the tab unit corresponding to each information device displayed on the display device 1B is displayed, and thus it is possible to easily determine whether or not the selected content can be copied.

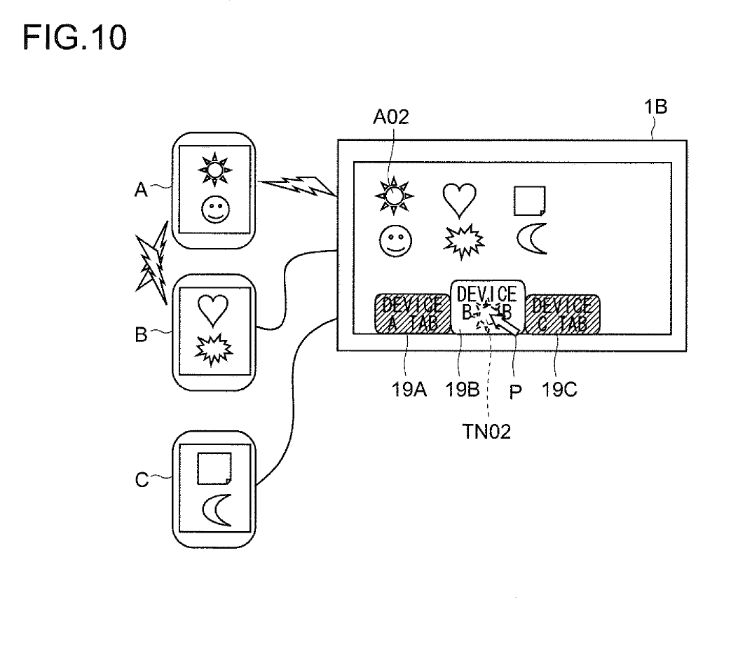

When the user drags the thumbnail image TN02, moves it to the enlarged and displayed tab 19B and is dropped as shown in FIG. 10, this drop operation is determined to be effective, with the result that the copying processing described above is started. In other words, as described above, through the main control unit 13, a transmission instruction is provided to the information device A to transmit the corresponding content to the information device B, a reception instruction is provided to the information device B to receive the content from the information device A and the transmission and reception are started between the information device A and the information device B.

As described above, the display device 1B of the present embodiment has, as the display section, the identification image display function of acquiring the identification information for identifying the content stored in the information devices and displaying the identification information as the identification image at one time, and drops the identification image on the information device displayed to be an information device on which copying can be performed to start the copying processing. In this configuration, since the identification image is used to allow the details of the content to be easily and visually recognized, it is possible to perform copying to the desired information device without erroneously recognizing the desired content.

Here, preferably, the identification information is, for example, the thumbnail information, and the identification image is the thumbnail image. In this configuration, a plurality of information devices A, B and C are connected to the display device 1B, and thus it is possible to acquire the thumbnail information for identifying the content stored in the information devices and display the thumbnail image on the display unit at one time. Hence, the thumbnail image with which the details of the content can be easily recognized is moved, on the screen of the display device, by the drag and drop method, and thus it is possible to provide an instruction to start an operation of copying the content between the information device of the copying source and the information device of the copying destination.

When the display section that simultaneously displays the content stored in the information devices has the function (copyability explicitly showing function) of distinguishing between the information device to which the selected content can be copied and the information device on which copying cannot be performed and producing the tab display, the tab display on a plurality of information devices is produced, and the thumbnails corresponding to the content displayed on the display screens are displayed at one time, with the result that it is possible to easily confirm the connected information devices, the content information stored in the information devices and the information device of the copying destination to which the content can be copied.

As described above, in the display device 1B of the second embodiment, on the screen of the display device 1B, the thumbnail image is dropped, by the drag and drop method, on the tab display unit corresponding to the information device of the copying destination, and thus it is possible to provide an instruction to start the copying processing on the content. In other words, in the present embodiment, it is possible to provide the display device 1B that can simultaneously connect a plurality of information devices, that simultaneously displays the information stored in the information devices and that can easily exchange the information.

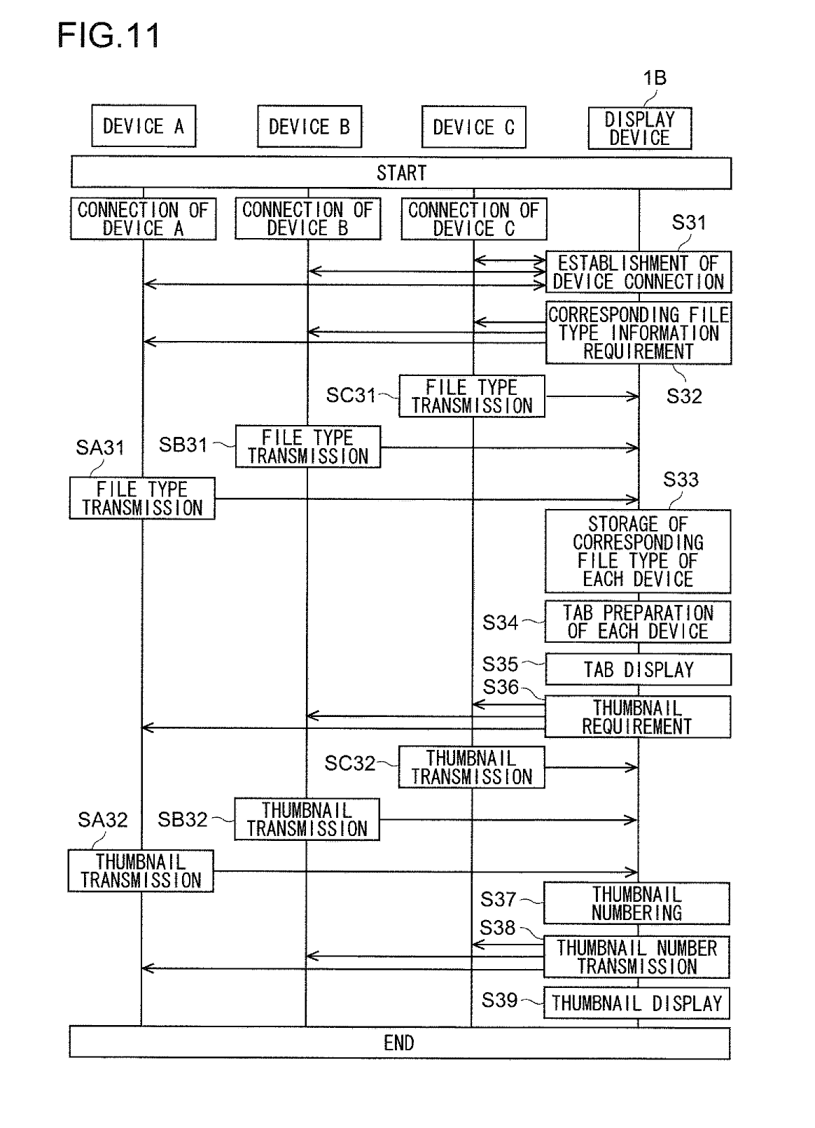

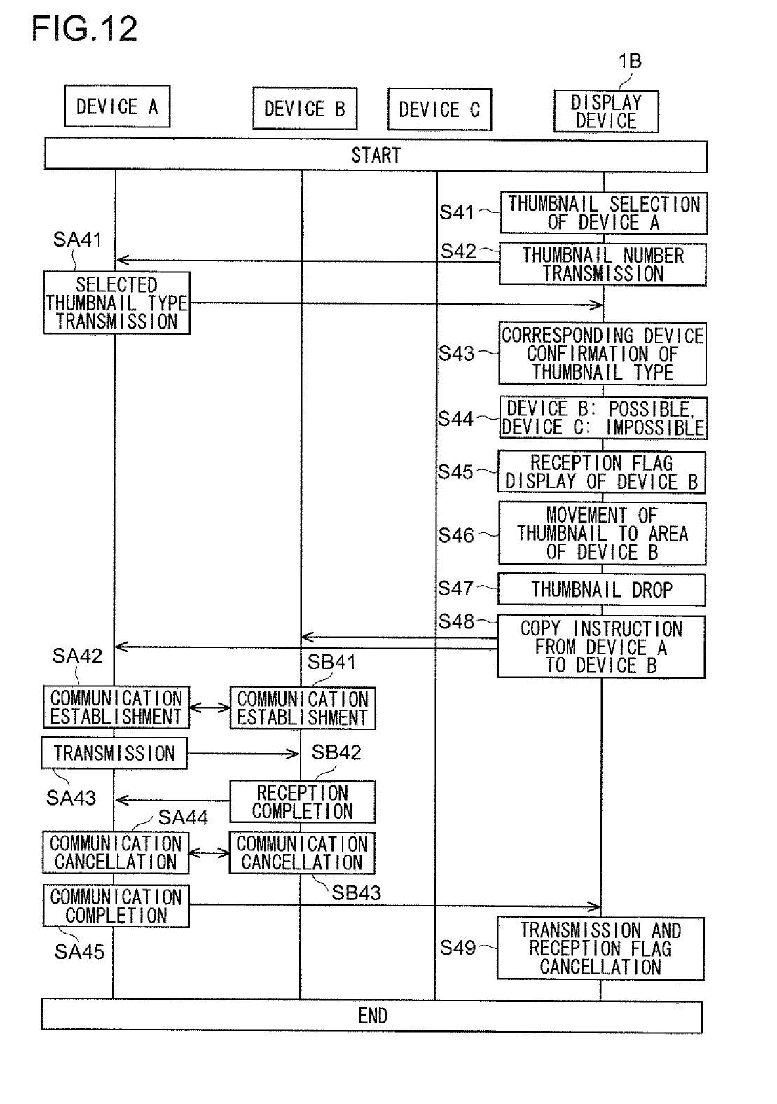

A method of controlling the display device 1B of the second embodiment will now be described with reference to the flowcharts shown in FIGS. 11 and 12. FIG. 11 is the flowchart showing a state where the tab display on the information device connected to the display device is produced, and then the desired thumbnail is displayed; FIG. 12 is the flowchart showing a state where the copying processing is further performed through the selected thumbnail.

As shown in FIG. 11, when the processing for connecting the information devices A, B and C to the display device 1B is started, the establishment of device connection in step S31 is performed by connecting the information devices through the section that connects the information devices (connection step).

Then, an operation of confirming the content information on the content displayed on the individual information devices A, B and C is performed. For example, file information included in the content information is required (step S32), and the file information transmitted (steps SA31, SB31 and SC31) from the information devices A, B and C is acquired. The file information (content information) is stored (step S33). The tabs corresponding to the information devices A, B and C are prepared (step S34), and the tab display is produced on a predetermined tab display area (step S35).

Then, the thumbnails corresponding to the content are required (step S36). The thumbnail information corresponding to the content is transmitted from each of the information devices A, B and C (steps SA32, SB32 and SC32), and the display device 1B numbers the received thumbnails (step S37) and displays them on the display unit 15 (step S39).

The numbers of the thumbnails added in step S37 are transmitted to the information devices A, B and C (step S38). Thus, with the numbers of the thumbnails, it is possible to transmit and receive operation information corresponding to the thumbnails.

Thereafter, the copying processing on the content can be performed according to the flowchart shown in FIG. 12.

First, according to the screen operation of the display device 1B by the user, the main control unit 13 selects the thumbnail image corresponding to the desired content (step S41: the selection of the thumbnail of the information device A). Then, the thumbnail number is transmitted to the information device A storing the selected content (step S42), and the information device A transmits a content type (thumbnail type) corresponding to the received thumbnail number to the display device 1B (step SA41).

When the display device 1B receives the content type (thumbnail type) from the information device A, whether or not this content type can be copied is determined on each information device (the confirmation of the corresponding device of the thumbnail type in step S43), and a determination (in step S44, the device B: possible, the device C: impossible) on its result is made. For example, the tab of the information device B that is determined to be an information device on which copying can be performed is enlarged and displayed (corresponding to the reception flag display of the information device B in step S45).

Then, the thumbnail is dragged to the enlarged and displayed tab of the information device B (corresponding to the movement of the thumbnail to the area of the device B in step S46), and is dropped (step S47), and thus the operation of copying the content stored in the information device A to the information device B is started. In other words, an instruction to transmit the file copy is provided from the display device 1B to the information device A, and an instruction to receive the file copy is provided to the information device B (copying from the device A to the device B in step S48).

Then, between the information device A and the information device B, a communication state is established (steps SA42 and SB41), and the transmission and reception of the content file are performed (step SA43). After the completion of the reception by the information device B, a file reception completion signal is transmitted to the information device A (step SB42).

Thereafter, the information device A and the information device B cancel the communication state (steps SA44 and SB43), and the information device A transmits a communication completion signal to the display device 1B (step SA45). When the display device 1B receives the communication completion signal from the information device A, the transmission and reception flag is cancelled (step S49). In other words, the enlargement and display of the tab of the information device B are cancelled, and the process returns to the initial state for the selection of the content.

Through the processing procedure in steps S41 to S49 described above, the operation of copying the content stored in the information device A to the information device B is completed. When a new type of copying processing is performed, the operation corresponding to steps S41 to S49 is performed on new content, and thus the new type of copying processing can be performed.

According to the display device and the method of controlling the display device in the second embodiment described above, it is possible to easily confirm, through the thumbnail image, the content stored in a plurality of information devices. Since the selection of the content desired to be copied allows the information device on which copying can be performed to be automatically displayed, it is possible to start, on the large screen of the display device, the copying processing on the thumbnail image corresponding to the content by the drag and drop method. In other words, in the present embodiment, it is possible to obtain the display device and the method of controlling the display device that can simultaneously connect a plurality of information devices, that simultaneously display the information stored in the information devices and that can easily exchange the information.

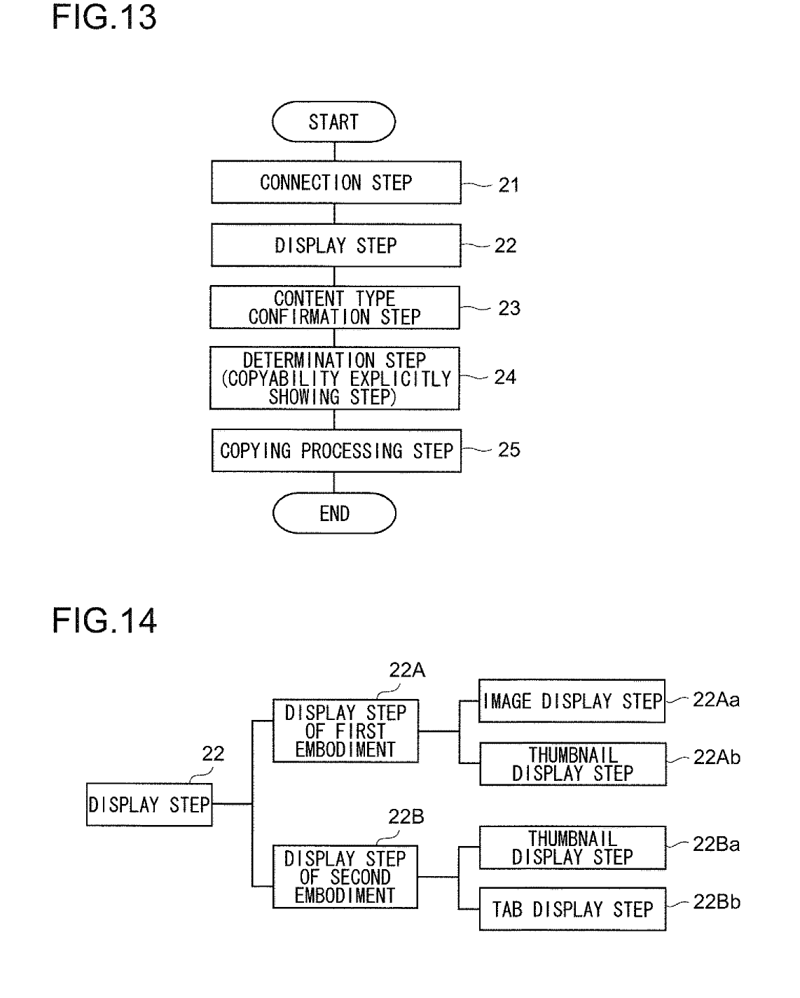

The processing step of the display device according to the present invention will now be described in further detail with reference to FIGS. 13 and 14.

As described above and as shown in FIG. 13, the display devices 1, 1A and 1B of the present invention have, as a series of processing steps of connecting a plurality of information devices so as to allow communication, displaying the content information stored in the individual display devices, selecting the content desired by the user and performing copying from one information device to another information device, the connection step 21, the display step 22, the content type confirmation step 23, the determination step 24 and the copying processing step 25. The determination step 24 may include a content copyability explicitly showing.

The connection step 21 is a step of connecting, through the wireless communication unit 11 and the wired communication unit 12, a plurality of information devices A, B and C so as to allow communication. The display step 22 is a step of displaying the display images on the information devices A, B and C or the content images corresponding to the content information displayed on the information devices A, B and C. The content type confirmation step 23 is a step of acquiring the content types of content stored in the information devices A, B and C and confirming the content types that can be input to the information devices A, B and C.

The determination step is a step of determining the information device that can correspond to the selected and predetermined content. In this step, for example, a display that implicitly shows the information device determined to be an information device to which the content selected and predetermined by the user can be copied may be produced (copyability explicitly showing step). The copying processing step 25 is a step of dropping the content image, by the drag and drop method, on the information device which is determined to an information device on which copying can be performed so as to provide an instruction to copy the content, of making the information device of the copying source and the information device of the copying destination communicate with each other and of starting the copying processing on the content.

Although not shown in the figure, it is obvious that the processing step of the display device according to the present invention has the copying destination limitation step of preventing the information device which cannot correspond to the predetermined content from being the copying destination of this content.

In the controlling method including the steps described above, it is possible to obtain the method of controlling the display device that can simultaneously connect a plurality of information devices through the connection step 21, that can display the information stored in the information devices through the display step 22, that can confirm the information device to which the predetermined content can be copied through the content type confirmation step 23 and the determination step 24 and that can easily exchange the information through the copying processing step 25.

As shown in FIG. 14, the display step 22 includes the display step 22A of the first embodiment and the display step 22B of the second embodiment. The display step 22A includes an image display step 22Aa and a thumbnail display step 22Ab; the display step 22B includes a thumbnail display step 22Ba and a tab display step 22Bb. In any of the steps, in the display step 22 of the present invention, a plurality of information devices A, B and C connected to the display devices 1, 1A and 1B and the content information stored in the information devices are simultaneously displayed such that they are easily and visually recognize.

The image display step 22Aa is a step of dividing the display images on the information devices on an individual display area basis and producing a display at one time; the thumbnail display step 22Ab is a step of acquiring the thumbnail information on the selected content from the information device storing the corresponding content and overwriting the display image as the thumbnail image with the acquired thumbnail information. The thumbnail display step 22Ba is a step of acquiring the thumbnails of the content displayed on the display images of the information devices and displaying the thumbnails as the thumbnail images at one time; the tab display step 22Bb is a step of producing a tab display on the information devices.

In the display step 22A including the image display step 22Aa and the thumbnail display step 22Ab, since the information devices connected to the display unit of the display device are divided and displayed, it is possible to easily confine the information device of the copying source and the information device of the copying destination. Since the copying processing can be started by a simple operation of only dropping the thumbnail image on the divided display area, it is easy for the user to perform the operation.

In the display step 22B including the thumbnail display step 22Ba and the tab display step 22Bb, the tab display is produced on the information devices, and it is possible to display whether the information device is an information device on which copying can be performed or an information device on which copying cannot be performed, by changing the size or the color of the tab, with the result that it is possible to perform the copying processing without erroneously recognizing the information device of the copying destination.

The display step 22A may include not only the image display step 22Aa and the thumbnail display step 22Ab but also the tab display step 22Bb; more preferably, in the display step 22A, it is possible to select and set the details of the display as necessary according to the requirement of the user.

In the display devices 1, 1A and 1B described above, a household TV device can also be utilized. Specifically, in a TV device including the display devices 1, 1A and 1B configured as described above, a household TV device whose size is being increased is used, a plurality of items of content stored in small-sized information devices can be confirmed at one time, and thus it is possible to easily perform the confirmation of the desired content and a copying processing operation, with the result that the usability is further enhanced.

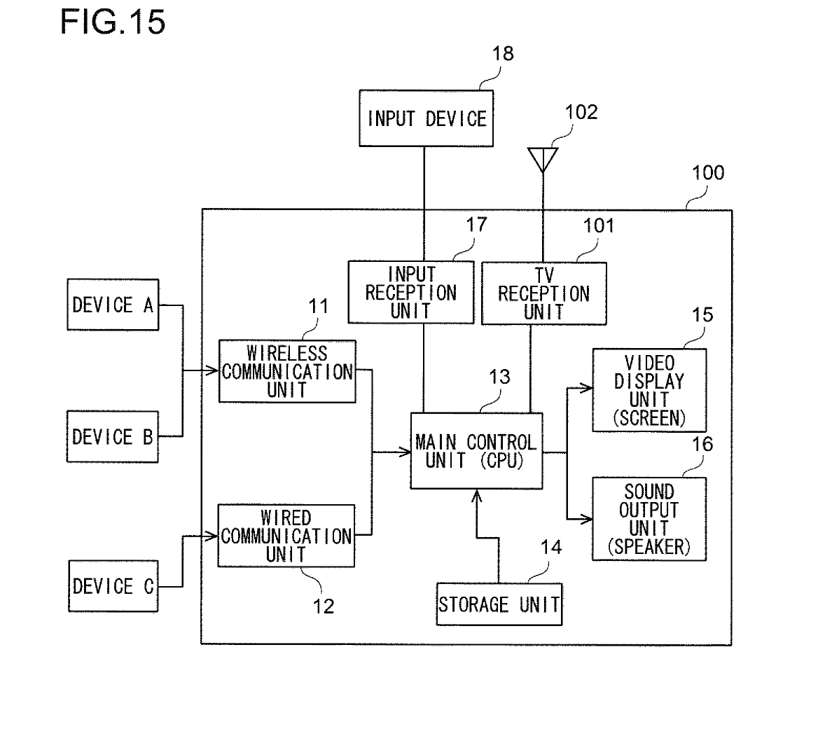

For example, as shown in FIG. 15, in a TV device 100 including an antenna 102 which receives TV broadcast and the TV device 100 having a TV reception unit 101, the wireless communication unit 11, the wired communication unit 12, the main control unit 13 (CPU), the storage unit 14, the display unit 15, the sound output unit 16 and the input reception unit 17, which are described above, are integrally provided. The main control unit 13 (CPU) controls the confirmation of the desired content and a series of processing steps of the copying processing operation as described above, and also controls a series of processing steps for receiving and viewing TV broadcast.

In the TV device 100 configured as described above, it is possible not only to view TV broadcast in a conventional use but also to confirm, on a large screen, content stored in a plurality of information devices possessed by the user, with the result that it is possible to easily perform the copying processing operation on the desired content.

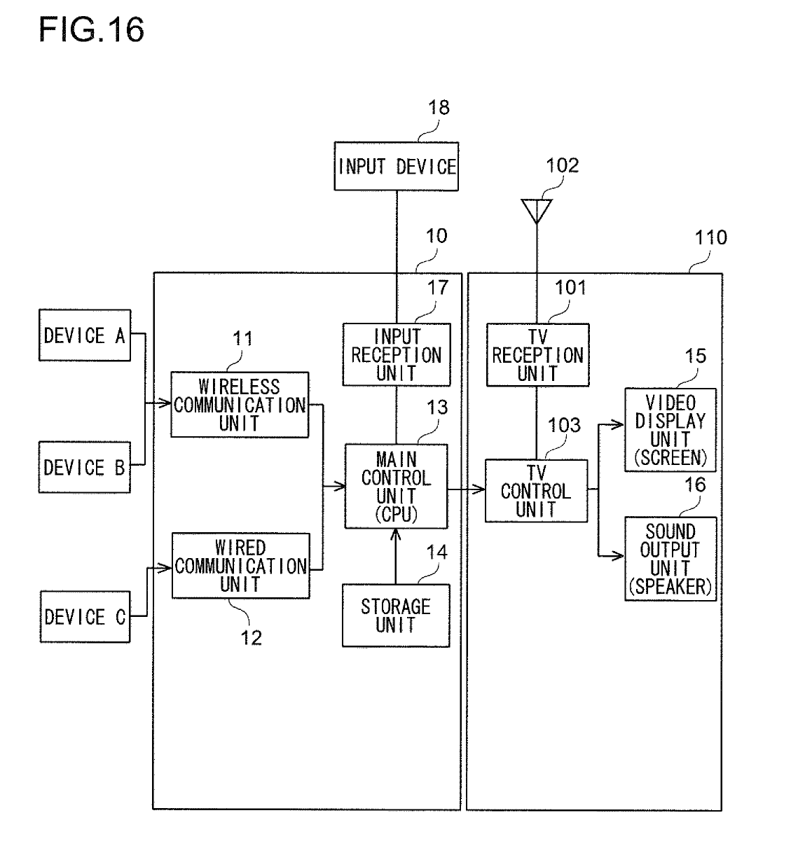

Furthermore, through the signal processing device having the functions described above, a conventional TV device may be used as the display unit. The following configuration can be said to be also the configuration of the present invention: for example, as shown in FIG. 16, the signal processing device 10 connected to the TV device 110 includes the connection function of connecting a plurality of information devices, the display function of displaying, on the display device, information on the content stored in the information devices, the content type confirmation function of confirming content types which can correspond to the information devices and the content types of content stored in the information devices, the determination function of determining the information device which can correspond to the content selected and predetermined from information displayed on the display device and the copying processing function of, when the information device which can correspond to the predetermined content is selected as the copying destination of the predetermined content, making the information device having the predetermined content and the information device of the copying destination communicate with each other to start the copying processing on the predetermined content; by performing an operation on the screen of the display device, it is possible to perform the copying processing from the information device of the copying source to the information device of the copying destination.

The signal processing device 10 includes the wireless communication unit 11, the wired communication unit 12, the main control unit 13, the storage unit 14 and the input reception unit 17; each of the communication units can simultaneously connect a plurality of information devices. The main control unit 13 (CPU) controls the confirmation processing on the application and a series of processing steps in start-up processing described above, can communication with a TV control unit 103 included in the TV device 110 and controls an image and video displayed on the display unit 15 of the TV device 110. Thus, it is possible to display, on the large display screen of the TV device 110, the information on the content stored in the information devices and to easily perform the copying processing on the desired content.

In the configuration described above, only by connecting the signal processing device 10 having the various types of functions described above to the conventional TV device 110, it is possible to simultaneously connect a plurality of information devices, simultaneously display the information stored in the information devices and easily perform the exchange of the information. This signal processing device 10 may be a recorder, a STB (set top box) or the like that is used by being connected to the conventional TV device or may be a device that is newly provided.

As described above, in the first embodiment of the present invention, since a plurality of information devices are simultaneously connected to the display device 1A, the display images and content information in the information devices are simultaneously displayed and the content stored in one information device is copied to another information device, on the large screen of the display device, the content information stored in the information devices is simultaneously displayed, and thus it is possible to easily utilize the content. Since copying processing can also be performed on the large screen of the display device 1A, it is easy for the user to perform the operation.

In the second embodiment of the present invention, since a plurality of information devices are simultaneously connected to the display device 1B, not only the content information stored in the information devices but also the tabs corresponding to the information devices are displayed at one time and the content information is moved by the drag and drop method to the corresponding tab to copy the content stored in one information device to another information device, it is possible to easily confirm, through the tabs displayed on the display device 1B, the information device that is connected and the information device to which the selected content can be copied and to easily and reliably perform the selection of the content and the copying processing on the content.

In the display devices described above, a household TV device can also be utilized. Specifically, in a TV device including the display devices 1, 1A and 1B configured as described above or a signal processing device that is connected to another display device to achieve the functions described above, a household TV device whose size is being increased is used, a plurality of items of content stored in small-sized information devices can be confirmed at one time, and thus it is possible to easily perform the confirmation of the desired content and a copying processing operation, with the result that the usability is further enhanced.

It should be considered that the embodiments disclosed herein are illustrative in all respects and not restrictive. The scope of the present invention is indicated not by the description of the above embodiments but by the scope of claims; furthermore, meanings equivalent to the scope of claims and all modifications within the scope are included.

For example, although the description has been given using, as the connection section that connects the display device and the information devices, the wireless communication unit and the wired communication unit, the present invention is not limited to this configuration; the main body of the information device may be connected by a plug-in method to allow communication.

Although the description has been given using the configuration where the three information devices are connected to the display device, the present invention is not limited to this configuration; two or four or more information devices may be connected.

Although the description has been given using the thumbnail image as the content information, the present invention is not limited to this configuration; a text display where the name of the content is displayed or an icon image may be used. Alternatively, application information may be used.

Although the description has been given using the configuration where the content stored in a plurality of information devices is displayed at one time, the present invention is not limited to this configuration; among a plurality of information devices, content stored in at least two or more information devices may be simultaneously displayed, the content may be divided in categories and be displayed or the content may be displayed by a scroll method so as to allow browsing.

As described above, in the present invention, it is possible to obtain the display device and the display system that can simultaneously connect a plurality of information devices, that display the information stored in the information devices and that can easily exchange the information, the method of controlling the display device and the signal processing device.

### INDUSTRIAL APPLICABILITY

Hence, the display device, the display system, the method of controlling the display device and the signal processing device according to the present invention can be applied to a case where, when information such as content is exchanged between portable information terminals having a small display screen, it is required to easily confirm, through a large screen, the content to be desired to be exchanged and easily perform an exchange operation.

What is claimed is:

1. A display device comprising:
a connection section that connects a plurality of information devices;
a display section that can display, on a display unit, information on content stored in the plurality of information devices;
a content type confirmation section that confirms a content type to which each of the information devices can correspond and a content type of content stored in each of the information devices;
a determination section that determines the information device which can correspond to content selected and predetermined from the information displayed on the display unit; and
a copying processing section that, when the information device which can correspond to the predetermined content is selected as a copying destination of the predetermined content, makes the information device having the predetermined content and the information device of the copying destination communicate with each other, and that starts copying processing on the predetermined content.

2. The display device of claim 1, further comprising:
a copying destination limitation section that prevents, through the determination section, the information device which is determined to be unable to correspond to the predetermined content from being the copying destination of the predetermined content.

3. The display device of claim 1,
wherein the display section simultaneously displays the information stored in at least two or more information devices among the plurality of information devices.

4. The display device of claim 1,
wherein the determination section compares a content type of the predetermined content with the content type to which each of the information devices can correspond so as to determine the information device that can correspond to the predetermined content.

5. The display device of claim 1,
wherein the determination section includes a copyability explicitly showing function of determining and explicitly showing the information device to which the predetermined content can be copied.

6. The display device of claim 1,
wherein the copying processing section provides an instruction to copy the content according to an operation of dropping the information on the content by a drag and drop method.

7. The display device of claim 1,
wherein the display section includes: an image display function of dividing a display image of each of the information devices on an individual display area basis and producing a display at one time; and an identification image display function of acquiring image information with which the selected content is identified from the information device storing the content and overwriting the display image as an identification image with the acquired image information and displaying the identification image, and
the identification image is dropped on the display area corresponding to the information device on which copying can be performed such that the copying processing is started.

8. The display device of claim 1,
wherein the display section includes an identification image display function of acquiring image information with which the content stored in the information devices is identified and displaying the image information as an identification image at one time, and
the identification image is dropped on the information device displayed as an information device on which copying can be performed such that the copying processing is started.

9. The display device of claim 7,
wherein the image information is thumbnail information, and the identification image is a thumbnail image.

10. The display device of claim 8,
wherein the image information is thumbnail information, and the identification image is a thumbnail image.

11. The display device of claim 7,
wherein background colors of the display area corresponding to the information device to which the selected content can be copied and the display area corresponding to the information device of a copying source are made to be a same first color, and a background color of the display area corresponding to the information device to which copying cannot be performed is made to be a second color different from the first color.

12. The display device of claim 1,
wherein a tab display is produced on the plurality of information devices that are connected.

13. The display device of claim 12,
wherein any one or both of a size and a color of a tab corresponding to the information device to which the selected content can be copied are changed, and the thumbnail image is dropped on the tab corresponding to the information device on which copying can be performed such that the copying processing is started.

14. The display device of claim 12,
wherein any one or both of a size and a color of a tab corresponding to the information device of a copying source and the information device on which copying cannot be performed are simultaneously changed.

15. The display device of claim 13,
wherein any one or both of a size and a color of a tab corresponding to the information device of a copying source and the information device on which copying cannot be performed are simultaneously changed.

16. A display system that is configured by connecting a plurality of information devices to the display device of claim 1,
wherein the display device includes:
a connection function that connects a plurality of information devices;
a display function that can display, on a display unit, information on content stored in the information devices;
a content type confirmation function that confirms a content type to which each of the information devices can correspond and a content type of content stored in each of the information devices;
a determination function that determines the information device which can correspond to content selected and predetermined from the information displayed on the display unit; and
a copying processing function that, when the information device which can correspond to the predetermined content is selected as a copying destination of the predetermined content, makes the information device having the predetermined content and the information device of the copying destination communicate with each other, and that starts copying processing on the predetermined content, and
an operation on a screen of the display device allows the copying processing from the information device of a copying source to the information device of a copying destination.

17. A method of controlling the display device of claim 1, comprising
a connection step of connecting a plurality of information devices;
a display step of being able to display, on a display unit, information on content stored in the information devices;
a content type confirmation step of confirming a content type to which each of the information devices can correspond and a content type of content stored in each of the information devices;
a determination step of determining the information device which can correspond to content selected and predetermined from the information displayed on the display unit; and
a copying processing step of, when the information device which can correspond to the predetermined content is selected as a copying destination of the predetermined content, making the information device having the predetermined content and the information device of the copying destination communicate with each other, and of starting copying processing on the predetermined content,
wherein an operation on a screen of the display device allows the copying processing from the information device of a copying source to the information device of a copying destination.

18. A signal processing device comprising:
a connection function that connects a plurality of information devices;
a display function that can display, on a display unit, information on content stored in the plurality of information devices;
a content type confirmation function that confirms a content type to which each of the information devices can correspond and a content type of content stored in each of the information devices;
a determination function that determines the information device which can correspond to content selected and predetermined from the information displayed on the display unit; and
a copying processing function that, when the information device which can correspond to the predetermined content is selected as a copying destination of the predetermined content, makes the information device having the predetermined content and the information device of the copying destination communicate with each other, and that starts copying processing on the predetermined content,
wherein an operation on a screen of the display device allows the copying processing from the information device of a copying source to the information device of a copying destination.
